(19) United States
(12) Patent Application Publication
(10) Pub. No.: US 2007/0231514 A1
(43) Pub. Date: Oct. 4, 2007

(54) RELEASE SHEET FOR DECORATIVE IMAGES

(75) Inventors: Luigi Filippino, Padova (IT); Stefano Cavetti, Ponte di Barbarano (VI) (IT); Dennis D. O'Rell, Geneva, IL (US); Rastislav Toth, Charleston, SC (US)

Correspondence Address: Levenfeld Pearlstein, LLC (ILLINOIS TOOL WORKS), 2 North LaSalle Street, Suite 1300, CHICAGO, IL, 60602, US

(73) Assignee: ILLINOIS TOOL WORKS INC., Glenview, IL (US)

(21) Appl. No.: 11/695,224

(22) Filed: Apr. 2, 2007

Related U.S. Application Data
(60) Provisional application No. 60/744,156, filed on Apr. 3, 2006.

(51) Int. Cl. B41M 5/40

(52) U.S. Cl. 428/32.81

(57) ABSTRACT

A release sheet for transferring a graphic onto an associated object includes a carrier film formed from a flexible polymeric material having melting point greater than about 150° C., a release layer disposed on the carrier film that is applied to the film in a solvent solution non-degradating to the carrier film, a transfer layer disposed on the release layer that is applied to the release layer in a solution non-degradating to the release layer and a graphic disposed on the transfer layer in a form that is non-degradating to the transfer layer. The release sheet containing the graphic is formulated for application to an associated object that is cured or vulcanized at an elevated temperature and humidity, such that the graphic transfers to the object during vulcanization or curing and the carrier film and release layer are removable from the object following vulcanization or curing.

### BACKGROUND OF THE INVENTION

The present invention relates to a label or graphic transfer system. More particularly, the present invention pertains to a label or graphic transfer system for applying a graphic to a rubber article during vulcanization, in which a carrier web is capable of withstanding the high temperature and high humidity of rubber curing or vulcanization.

Known in-mold labels for applying graphics to a rubber article during vulcanization or curing use a homo-polymer film made from polymers such as polyvinyl fluoride (PVF) or cellulose triacetate having the graphic printed on the film. The image is deposited on the film using known printing methods, such as screen printing, thermal transfer, gravure printing and the like. The inks used to produce the image are typically rubber based and are capable of chemically bonding to the rubber article during vulcanization. The film serves as a carrier for the graphic, and is removed once the rubber article is cured.

In order to decorate the article, the label is placed on the article so that the graphic image is in direct contact with the article. The article and label (the carrier with image) are placed in a mold and are cured at an elevated temperature. In an alternate method, the label (again, the carrier with the graphic) is placed in the mold with the graphic exposed (e.g., graphic “side up”) and the elastomer is injected or placed in the mold. During curing or vulcanization the image bonds to the article. Following vulcanization, the carrier film is removed.

When the carrier is removed, the graphic (now a “transfer”) remains on the cured article and transfers from the film carrier to decorate the cured rubber article. The film must be able to withstand temperatures in excess of 300° F. for 20 minutes or more, in an environment that can be saturated with water vapor. Importantly, after the article is removed from the mold, the carrier film must readily come off the surface of the article, preferably in one piece, without picking or pulling any portion of the transferred image or the rubber surface that was decorated.

While in the mold, under heat and pressure, the film is pushed into the rubber surface which, after it is removed, leaves an indentation in the rubber surface. Minimizing the depth of this indentation can, in certain instances, be critically important, for example, to automotive power transmission belt manufacturers, because the indentations can be a source of mechanical vibration when the belts are installed in an engine.

One film for use as the release sheet is a polyvinyl fluoride (PVF) sheet commercially available from E.I. duPont under the name TEDLAR®. Although this film functions well in the required environment, an alternative non-fluorine-containing film having these characteristics is desired.

### BRIEF SUMMARY OF THE INVENTION

A release sheet for transferring a graphic onto an associated object includes a carrier film formed from a flexible polymeric, non-fluorinated material having melting point greater than about 150° C., a release layer that is disposed on the carrier film, a transfer layer that is disposed on the release layer and a graphic that is disposed on the transfer layer.

Each layer is applied to the film of over a prior layer in such a manner that it is non-degradating to (i.e., does not degrade) the prior layer. That is, the release layer applied in a solvent solution that is non-degradating to the carrier film, the transfer layer is applied in a manner that is non-degradating to the release layer and the graphic is applied in a manner that is non-degradating to the transfer layer.

The release sheet containing the graphic is formulated for application to an associated object that is cured or vulcanized at an elevated temperature. The graphic transfers to the object during curing or vulcanization and the carrier film and release layer are removable from the object following curing or vulcanization.

An alternate UV curable transfer layer is also disclosed, as is an alternate method for creating the graphic image using a digitally controlled printing process. A method for transferring a graphic to an associate object during vulcanization or curing is also disclosed.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a cross-sectional view of a release sheet for decorative images embodying the principles of the present invention.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

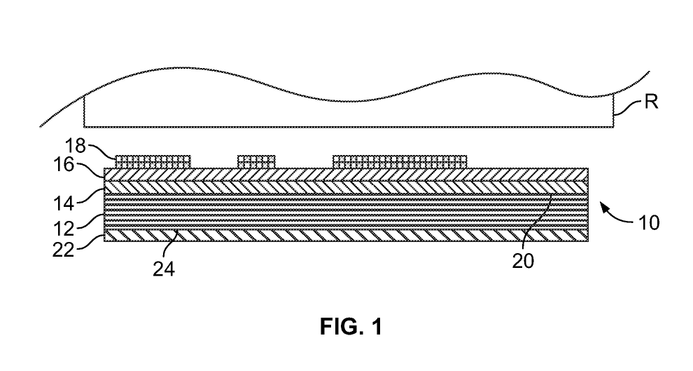

Referring now to the figures and in particular, to FIG. 1 there is shown an exemplary in-mold decoration 10 embodying the principles of the present invention. The decoration or sheet 10 includes a carrier film 12, a release layer 14, a transfer or print layer 16 and a graphic 18. The present combination of materials provides a release sheet 10 for use in-mold, for transferring a graphic 18 to an associated object R, as that object R is cured or vulcanized at an elevated temperature. If the vulcanization process is carried out in a steam heated autoclave, then the process would also be carried out at a high humidity. After transfer of the graphic 18, e.g., after vulcanization or curing, the carrier film 12 and release layer 14 are removable from the object R without picking any of the object R material or the graphic 18. An exemplary object R is a vulcanized rubber article R, such as an automotive engine timing belt, drive belt, hose, tire or the like.

A suitable carrier film 12 has a melting point greater than about 300° F. (150° C.), preferably greater than about 345° F. (175° C.) and most preferably greater than about 390° F. (200° C.). Such a film is a non-fluorinated film. A preferred film is a uni-axially or bi-axially oriented films formed from nylon, such as nylon 6, nylon 66, nylon 46 and the like, having a melting point greater than about 175° C. The film should have good hydrolysis resistance and a soft hand (e.g., be soft and flexible, exhibiting good drape behavior). The thickness of the film, t₁₂, may range from 10 microns to 100 microns depending on the particular rubber article being decorated. In one preferred form of the invention the film thickness t₁₂ lies between 15 and 25 microns where the indentation mark due to the film needs to be minimized. In other situations where the carrier film indentation mark in the cured rubber article is not a critical factor, the film thickness t₁₂ may be about 50 to 100 microns. The film may be a single layer construction or it may be a laminate structure formed by laminating two or more layers together with an appropriate adhesive. The laminate structure may be formed from films having the same or different compositions and the same or different thicknesses. Suitable film materials, other than the above-noted nylon materials, include polyesters, including polyethylene terephthalate (PET), polybutylene terephthalate (PBT) and the like, polypropylene and acetates.

The release coat or release layer 14 is applied over the film 12. The release coat 14 facilitates the easy removal of the film 12 after curing or vulcanization of the article R. Importantly, the release layer 14 also facilitates the transfer of the final or top coat (e.g., the print layer 16) to the cured article R. A preferred release coat is a wax release coat. One release coat is a wax release coat that has a drop point between about 175° F. (80° C.) and 250° F. (120° C.) and an acid value of about 20 mg KOH/gram.

The drop point assures the correct degree of release from the cured rubber article R, while the acid value provides sufficient surface energy to provide a good, ink receptive surface. If the acid value is too low, the wax surface 14 is difficult to print on while if it is too high, it hampers the release behavior. Suitable waxes include an oxidized polyethylene wax, such as that commercially available from Clariant Corporation of Muttenz, Switzerland (with offices in Charlotte, N.C.), under the trade name LICOWAX® PED521. Those skilled in the art will recognize that numerous other waxes can be used in the present release sheet, provided that they have similar drop points and acid values. Such other waxes need not be of the same chemical class, but could be other synthetic or natural waxes.

The use of the wax coating 14 also yields a coated product that is flat and free of curl even when coated on only one side 20 of the film 12. Optionally, the film 12 can be coated on both sides (e.g., an anti-blocking coat 22 to the non-printed side 24), which has the benefit of providing a greater assurance that the film 12 does not curl, and prevents the printed graphics 18 from sticking to the back-side 24 of the carrier film 12, for example, when the labels (sheet 10 is) are in a roll form. The anti-blocking coating 22 can be a wax or other coating the formulation of which will be appreciated by those skilled in the art.

The wax is usually applied as a coating employing a solution using a non-polar solvent to minimize the potential solvent attack on the carrier film, which could otherwise adversely affect the film's properties. The wax coating can also be applied in a solvent free process using molten wax applied via a gravure process, slot die coating or other process capable of applying a thin uniform coating of wax to the film carrier. The wax can also be applied as an aqueous emulsion or dispersion, which after drying provides a smooth, uniform coating on the surface of the film. If a wax dispersion is used, the particle size of the wax is preferably less than 20 microns in order to achieve a smooth uniform coating.

The transfer or print layer 16 (also descried as a print receptive layer) is applied over the wax release coat. The print layer 16 is preferably a thermoplastic or elastomer. The print layer 16 has good adhesion to the rubber R that is used to form the article R and has good ink receptivity. Polyvinyl chloride (PVC) is one exemplary material that has been found to be a suitable material for use as the print layer 16. Advantageously, PVC has been shown to be usable with a broad range of cured rubbers. The PVC may be a homopolymer or a copolymer, and resins of this type will be recognized by those skilled in the art. The print receptive layer 16 may also be a thermoplastic that contains an unsaturation (carbon-carbon double bond) capable of reacting during the vulcanization process. Examples of such thermo plastics include copolymers of butadiene (impact styrene), copolymers of acrylonitrile, butadiene and styrene (ABS), copolymers of ethylene, polypropylene and dienemonomers (EPDM), and ethylene-vinyl acetate copolymers.

The print layer 16 is an important coating that serves a number of purposes. First, the print layer 16 provides a print receptive surface that facilitates the printing of clean sharp graphics. Second, it provides good release properties from the carrier film 12 relative to the cured rubber article R. It also provides a barrier between the carrier film 12 and the cured rubber article R to prevent sticking between the cured article R and the carrier 12. Moreover, the print layer 16 transfers to the cured article R on removal of the carrier 12 and provides additional protection to the graphics 18 on the cured article R. The print layer 16 is preferably a transparent or translucent (light transmissive) layer so as to permit viewing the graphic 18 though the print layer 16. The print layer can contain other constituents, such as fillers, anti-oxidants, light stabilizers, defoaming agents, wetting agents and the like, as will be appreciated by those skilled in the art.

Through proper formulation of the print layer 16 and wax coating 14, a gloss or matte finish can be achieved in the cured transferred graphic. Moreover, different surface effects can be created by selecting films 12 having a particular, desired pattern. The film 12 thickness t₁₂ is, however, preferably thin, about 1 mil (0.001 inches or 25 microns) so as to minimize the formation of an impression or indentation in the cured article R.

Desirably, the print layer 16 is soluble in a polar solvent so that the solvent in the print layer 16 does not dissolve or otherwise disturb the wax coating 14 (which is preferably soluble in a non-polar solvent). In this manner, the solvents of each layer 14, 16, 18 are non-degradating to, e.g., do not adversely affect, a prior or subsequent layer and are non-degradating to, e.g., not adversely effected by, a prior to subsequent layer. For purposes of the present disclosure, non-degradating is defined as not adversely affecting a prior layer such that the subsequent layer in solvent does not dissolve, swell, distort or otherwise chemically or physically attack the prior layer so as to compromise the chemical and/or physical characteristics and/or properties of that prior layer.

The ink or colorant used for the graphic layer 18 is a rubber (with optional additives, e.g., surfactants, antioxidants, antiozonants, curatives including sulfur, accelerators, metal salts, peroxides, waxes, plasticizers, fillers, reinforcing or strengthening agents, etc) and pigment composition dissolved in a suitable non-polar solvent, such as a C9-10 aromatic solvent, as shown in Formulation 3 in Table I. Rubbers suitable for use in the graphic layer 18 include both natural and synthetic rubbers. Examples of suitable rubbers include, but are not restricted to, Hypalon (a chlorosulfonated polyethylene manufactured by DuPont), Neoprene (a polymer of chloroprene developed by DuPont), SBR (a copolymer of styrene and butadiene), SBS or SIS type rubbers (block copolymers of styrene-butadiene-styrene, or styrene-isoprene-styrene commercially available under the trade name Kraton), polybutadiene, natural rubber, polyisoprene, nitrile rubber, ethylene-propylene rubbers (EP, EPDM), butyl and halobutyl rubbers (IIR, BIIR, CIIR). Suitable rubber formulations may be prepared from mixtures of rubbers, including both natural and synthetic. The pigment compositions typically include organic pigments, dispersing agents, and other additives well known to those skilled in the art. In an alternative, the pigments may be inorganic in composition.

It is important to properly select the solvent for each successive layer. The solvent used in the wax release layer 14 should be selected to be non-degradating to and have minimum effect on the carrier web 12, and should not attack, distort, swell or dissolve the film carrier 12. Likewise, the solvent used in the print layer 16 (over the release wax 14) should be selected to be non-degradating to and have minimum effect on the wax layer 14. The print layer 16 material should be selected to have a very low solubility in the solvent used to make inks such as those used in the graphic layer 18. Accordingly, although the solvent used for the print layer 16 is strong enough to dissolve the print layer resin (material) it does not attack the wax layer 14. The solvent used in the inks (the graphics 18) should likewise be selected to have a minimum effect on the print layer 16.

An exemplary transfer sheet 10 was fabricated. The sheet 10 was formed from a Nylon 6 film 12 that was about 1 mil thick, t₁₂, that was coated with a solution of wax in an aromatic solvent (as shown in Formulation 1 in Table I) at a coating weight of five (5) grams per square meter (gsm). The coated film was then passed through a drying oven at 70° C. to dry the coating 14.

The dried wax coating 14 was then over-coated with a solution of print layer formulated from a PVC resin in a cyclohexanone solvent (as shown in Formulation 2 in Table I) at a coating weight of seven (7) gsm, followed by oven drying at 158° F. (70° C.) to form a continuous print layer 16.

The print layer 16 coating readily accepted the screen printed graphic 18 design which was printed with a rubber and pigment composition in a non-polar solvent (such as a C9-10 aromatic, as shown in Formulation 3 in Table I). The graphic 18 formulation included a surfactant and a curative (dipentamethylene thiuram tetrasulfide). The printed design 18 was then dried at 70° C., and the design was applied to an uncured rubber article R followed by vulcanization of the article R at a temperature in excess of 125° C. After curing the rubber article R, the nylon (carrier) film 12 readily released from the article R and the graphic design 18 without any picking of the article R rubber material.

TABLE I

| | |
|---|---|
| MATERIAL | GRAMS |

FORMULATION 1
WAX LAYER

| | |
|---|---|
| PED 521 Wax | 9.5 |
| Aromatic 100 | 88.0 |
| Ethyl Cellulose N14 | 2.5 |
| TOTAL | 100.0 |

FORMULATION 2
PRINT LAYER

| | |
|---|---|
| PVC Resin | 960 |
| Cyclohexanone | 4,175 |
| N-Methylpyrrolidone | 500 |
| Ethoxyethyl propionate (EEP) | 4,450 |
| Bentone 27 | 100 |
| TOTAL | 10,185 |

FORMULATION 3
GRAPHIC PRINT

| | |
|---|---|
| Hypalon Rubber | 20 |
| Aromatic 100 Solvent | 80 |
| Pigment(s) | 30 |
| Surfactants | 5 |
| Dipentamethylene Thiuram Tetrasulfide | 1 |
| TOTAL | 104.0 |

An alternate ultraviolet (UV) curable print layer 16 was also formulated from a cycloaliphatic epoxy resin present in a concentration of about 75 to 80 percent by weight of the print layer formulation, a polyol (tri-functional) present in a concentration of about 18 to 20 percent by weight of the print layer formulation, a photoinitiator present in a concentration of about 1.0 to 3.0 percent by weight of the print layer formulation, a wetting agent present in a concentration of about 0.5 to 1.5 percent by weight of the print layer formulation, and a thixotropic agent present in a concentration of about 0.1 to 1.0 percent by weight of the print layer formulation.

Alternately, it is anticipated that the graphic design can be provided through a digitally controlled process. On such process is a thermal transfer printing process. In such a process, the graphic design 18 is created by transferring a colored resin composition from a ribbon to the print layer 16 using a thermal printer. Such thermal printing systems will be appreciated by those skilled in the art. Other digitally controlled printing processes include inkjet printing and electrostatic processes employing powdered toners or liquid dyes. Such methods provide advantages in that they permit the application of variable data. That is, the data can be printed using, for example, a laser to transfer an ink from a ribbon to the transfer layer. In this manner, the printing can be specifically created for or modified for a particular use. For example, when used for automotive belts and the like, the variable printing can be used to indicate lot numbers, dates of manufacture or the like.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the invention.

What is claimed is:

1. A release sheet for transferring a graphic onto an associated object, comprising:
a carrier film, the carrier film formed from a flexible polymeric material having melting point greater than about 150° C.;
a release layer disposed on the carrier film, the release layer applied to the film in a release layer solvent solution that is non-degradating to the carrier film;
a transfer layer disposed on the release layer, the transfer layer applied to the release layer in a solution that is non-degradating to the release layer; and
a graphic disposed on the transfer layer, the graphic being present in a form that is non-degradating to the transfer layer,
wherein the release sheet containing the graphic is formulated for application to an associated object that is cured or vulcanized at an elevated temperature, and wherein the graphic transfers to the object during curing or vulcanization and the carrier film and release layer are removable from the object following curing or vulcanization.

2. The release sheet in accordance with claim 1 wherein the graphic is printed using a composition having a graphic solvent that is non-degradating to the transfer layer.

3. The release sheet in accordance with claim 1 wherein the carrier film is a nylon film.

4. The release sheet in accordance with claim 1 wherein the release layer is a wax release layer.

5. The release sheet in accordance with claim 4 wherein the release layer solvent is a non-polar solvent.

6. The release sheet in accordance with claim 5 wherein the release layer solvent is an aromatic solvent.

7. The release sheet in accordance with claim 4 wherein the wax release layer has a drop point of about 80° C. to 120° C.

8. The release sheet in accordance with claim 4 wherein the wax release layer is an oxidized polyethylene wax.

9. The release sheet in accordance with claim 1 wherein the wax release layer has an acid value of about 20 mg KOH/gram.

10. The release sheet in accordance with claim 1 wherein the release layer is a first release layer and wherein the film has a second release layer on a side opposite of the first release layer.

11. The release sheet in accordance with claim 1 wherein the transfer layer is applied in a transfer layer solvent solution.

12. The release sheet in accordance with claim 11 wherein the transfer layer is a polymeric resin.

13. The release sheet in accordance with claim 12 wherein the polymeric resin is a PVC resin.

14. The release sheet in accordance with claim 13 wherein the PVC resin is a copolymer of PVC.

15. The release sheet in accordance with claim 12 wherein the polymeric resin is a copolymer of polyvinylbutadiene.

16. The release sheet in accordance with claim 12 wherein the polymeric resin is a copolymer of ethylenevinylacetate.

17. The release sheet in accordance with claim 13 wherein the solvent is a polar solvent.

18. The release sheet in accordance with claim 1 wherein the transfer layer is a transparent or a translucent material.

19. The release sheet in accordance with claim 1 wherein the transfer layer is formulated from an ultraviolet curable material.

20. The release sheet in accordance with claim 19 wherein the ultraviolet curable material includes an epoxy resin, a polyol and a photoinitiator.

21. The release sheet in accordance with claim 2 wherein the graphic is applied as a rubber and pigment composition in a solvent.

22. The release sheet in accordance with claim 21 wherein the graphic solvent is a non-polar solvent.

23. The release sheet in accordance with claim 22 wherein the graphic solvent is an aromatic solvent.

24. The release sheet in accordance with claim 1 including a surfactant in the graphic solvent.

25. The release sheet in accordance with claim 1 wherein the graphic is printed on the transfer layer.

26. The release sheet in accordance with claim 25 wherein the graphic is printed on the transfer layer using a digitally controlled printing process.

27. The release sheet in accordance with claim 25 wherein the graphic is a variable graphic.

28. The release sheet in accordance with claim 25 wherein the variable graphic is printed using one of an inkjet process, an electrostatic process and a thermal transfer process.

29. A method for transferring a graphic to an associated object comprising the steps of:
providing a release sheet having a carrier film formed from a flexible polymeric material having melting point greater than about 300° F., a release layer disposed on the carrier film and applied to the film in a solvent solution non-degradating to the carrier film, a transfer layer disposed on the release layer and applied to the release layer in a solvent solution non-degradating to the release layer and a graphic disposed on the transfer layer in a manner that is non-degradating to the transfer layer;
introducing the release sheet to the associated object with the graphic in contact with the associated object;
vulcanizing or curing the associated object at an elevated temperature and humidity with the graphic in contact therewith; and
releasing the release sheet including the carrier film and at least a portion of the release layer such that the graphic and at least a portion of the transfer layer remain on the associated object.

30. The method in accordance with claim 29 wherein the graphic is applied as an ink solution.

31. The method in accordance with claim 29 wherein the graphic is printed on the transfer layer.

32. The release sheet in accordance with claim 29 wherein the graphic disposed on the transfer layer is digitally printed on the transfer layer.

33. The release sheet in accordance with claim 32 wherein the graphic is a variable graphic.

34. The release sheet in accordance with claim 32 wherein the variable graphic is printed on the transfer layer using a thermal transfer process.
